(19) United States
(12) Patent Application Publication
(10) Pub. No.: US 2012/0005743 A1
(43) Pub. Date: Jan. 5, 2012

(54) INTERNAL NETWORK MANAGEMENT SYSTEM, INTERNAL NETWORK MANAGEMENT METHOD, AND PROGRAM

(75) Inventors: Shigeki KITAZAWA, Tokyo (JP); Seiji Fujii, Tokyo (JP); Yoshiharu Saiga, Tokyo (JP); Koichi Yahagi, Tokyo (JP); Takaaki Nakano, Tokyo (JP); Takaya Kato, Tokyo (JP)

(73) Assignees: MITSUBISHI ELECTRIC CORPORATION, Chiyoda-ku (JP); The Bank of Tokyo-Mitsubishi UFJ, Ltd., Chiyoda-ku (JP); Mitsubishi Electric Infor. Network Corp., Chiyoda-ku (JP)

(21) Appl. No.: 13/074,475

(22) Filed: Mar. 29, 2011

(30) Foreign Application Priority Data
Jun. 30, 2010 (JP) 2010-148669

(51) Int. Cl. G06F 21/20; G06F 15/16

(52) U.S. Cl. 726/13

(57) ABSTRACT

A relay apparatus log analysis apparatus 132 periodically receives log data from a relay apparatus 112, when detecting a traffic abnormality, an abnormality detection apparatus 131 notifies the IP address of a terminal device that has caused the abnormality to the relay apparatus log analysis apparatus 132, the relay apparatus log analysis apparatus 132 analyzes traffic information generated by a router apparatus 121 to identify a time when the traffic abnormality has occurred, the relay apparatus log analysis apparatus 132 analyzes the log data, based on the occurrence time of the traffic abnormality and the IP address of the terminal device that has caused the abnormality, identifies an address accessed by the terminal device, regards the identified address as the destination from the malware, and sets the relay apparatus 112 so as to block a packet to the address.

### TECHNICAL FIELD

The present invention relates to a technology that detects a communicating destination from malware and blocks an access to the communicating destination from the malware.

The malware collectively refers to malicious and harmful software or malicious and harmful codes such as computer viruses, computer worms, back doors, keyloggers, spywares, and Trojan Horses, which have been generated with an intention of performing a wrongful and harmful operation.

### BACKGROUND ART

Conventionally, as a technology of coping with the malware, which is a malicious program, a technology of automatically applying an update patch or anti-virus countermeasure software has been commonly introduced. The update patch (being a module for fixing a bug of a program) takes care of vulnerability of an operating system or software which may be abused by the malware.

There is also a method of detecting an abnormality in behavior of communication traffic (hereinafter referred to just as traffic) and blocking communication from a transmission source of abnormal traffic (as disclosed in Patent Documents 1, 2, and 3, for example).

Patent Document 1 discloses a method of assigning a sensor device that monitors traffic to each terminal or a server and discarding a received packet when an amount of received data at the terminal exceeds a predetermined threshold value, and a method of detecting information leakage or an unauthorized access, based on information obtained from the sensor device, and blocking a packet associated the information leakage or the unauthorized access.

Patent Documents 1, 2, and 3 disclose a method of setting a list (blacklist) of malicious URLs (Uniform Resource Locators) in advance, and blocking an access to each of the listed URLs, and a method of determining that a DoS (Denial of Service) attack is underway when a large number of access requests are transmitted in a short period of time, and registering an access request source in an access denial list, thereby blocking communication with the access request source.

### Related Art Documents

[Patent Document 1] JP-2008-141352A

[Patent Document 2] JP-2009-164712A

[Patent Document 3] JP-2009-157521A

### SUMMARY OF INVENTION

### Technical Problem

In the methods of the related arts (Patent Documents 1, 2, and 3), it is necessary to set the list (blacklist) of malicious URLs in advance. The malicious URLs exist for a short period of time, and new URLs are generated one after another. Thus, there is a problem that even if a latest blacklist is applied, a failure to block an access to a malicious URL may occur.

The present invention mainly aims to solve the above-mentioned problem. A main object of the invention is to implement a configuration capable of effectively block communication to a communicating destination even from unknown malware that is not included in a blacklist.

### Solution to Problem

An internal network management system according to the present invention that manages an internal network including a plurality of terminal devices and an abnormality detection apparatus which detects a traffic abnormality using traffic information, and communicates with a relay apparatus that connects the internal network and an external network, the internal network management system may include:

a first communication unit that receives an abnormality occurrence address notification notifying an abnormality occurrence address being a communication address of an abnormality occurrence terminal device identified by the abnormality detection apparatus as an origin of a traffic abnormality occurred in the internal network, and receives, as traffic information to be analyzed, the traffic information from which the abnormality detection apparatus has detected the traffic abnormality;

a traffic information analysis unit that analyzes the traffic information to be analyzed, based on the abnormality occurrence address indicated by the abnormality occurrence address notification and the communication address of a terminal device being a transmission source of a packet indicated and a transmission time of the packet indicated in the traffic information to be analyzed, and identifies a start time of the traffic abnormality detected by the abnormality detection apparatus.;

a second communication unit that receives from the relay apparatus log data indicating a communication address of a transmission source, a communication address of a transmission destination, and a process time at which a process on each outbound packet has been performed at the relay apparatus, for each outbound packet transmitted from the internal network to the external network;

a communication blocking address specification unit that extracts, from the log data received by the second communication unit, the outbound packet in which the process time at the relay apparatus is after the start time of the traffic abnormality identified by the traffic information analysis unit and the communication address of the transmission source is the abnormality occurrence address, and specifies the communication address of a transmission destination of the extracted outbound packet as a communication blocking address; and

a blocking instruction unit that instructs the relay apparatus not to transfer to the external network the outbound packet having the communication blocking address specified by the communication blocking address specification unit as the transmission destination.

### Advantageous Effect of Invention

According to the present invention, when a traffic abnormality has occurred, the log data of the relay apparatus is analyzed. Then, the outbound packet in which the communication address of the transmission source is the abnormality occurrence address is extracted to specify the communication blocking address. Then, the relay apparatus is set so that the outbound packet having the communication blocking address as the transmission destination is not relayed. With this arrangement, communication even to a communicating destination from unknown malware not listed in a blacklist may be effectively blocked.

### BRIEF DESCRIPTION OF DRAWINGS

FIG. 1 is a diagram showing a configuration example of a system in a first embodiment;

FIG. 2 is a diagram showing a configuration example of a relay apparatus log analysis apparatus in the first embodiment;

FIG. 3 is a flowchart diagram showing an operation example of the system in the first embodiment;

FIG. 4 is a flowchart diagram showing an operation example of the system in the first embodiment; and

FIG. 5 is a diagram showing a hardware configuration example of the relay apparatus log analysis apparatus in the first embodiment.

### DESCRIPTION OF EMBODIMENT

### First Embodiment

A description will be directed to a method according to a first embodiment. In this method, a traffic behavior is monitored inside an enterprise. When a traffic abnormality occurs, a malicious URL considered to be a malware communicating destination is identified, and a blacklist is dynamically updated. With this arrangement, a countermeasure against communication to the malicious URL that is not commonly known may also be taken.

Specifically, in the method shown in this embodiment, when the traffic abnormality occurs, the URL (example of a communication address) that may cause the traffic abnormality is identified. Then, access to the identified URL from inside the enterprise is blocked. With this arrangement, communication to the communicating destination from the unknown malware may also be effectively blocked.

In this embodiment, the description will be given using an enterprise's internal network as an example. A system according to this embodiment may be applied to an internal network of a public office or a predetermined organization as well.

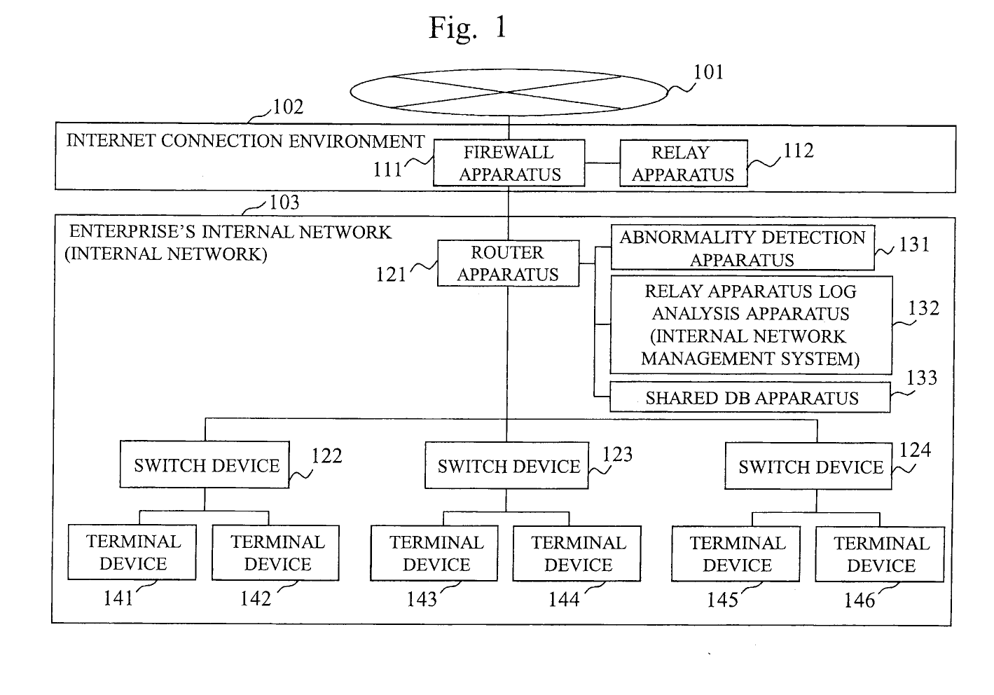

FIG. 1 shows a configuration example of the system in this embodiment.

Referring to FIG. 1, an Internet 101 is a network which is present outside an enterprise's internal network 103 that will be described later, and is an example of an external network.

An Internet connection environment 102 is provided to connect the enterprise's internal network 103 and the Internet 101.

The enterprise's internal network 103 is a network disposed within the enterprise, and includes networks referred to as a LAN (Local Area Network) and an intranet.

The enterprise's internal network 103 is an example of an internal network.

In the Internet connection environment 102, a Firewall apparatus 111 and a relay apparatus 112 are placed. A packet (outbound packet) from the enterprise's internal network 103 to the Internet 101 is directed to the relay apparatus 112, and is then transmitted through the Firewall apparatus 111.

Specifically, the relay apparatus 112 connects the enterprise's internal network 103 and the Internet 101. The relay apparatus 112 receives the outbound packet for the Internet 101 from the enterprise's network 103, and transfers the received outbound packet to the Internet 101.

The relay apparatus 112 periodically generates log data on the received outbound packet in a predetermined cycle.

The relay apparatus 112 generates an access log or an email transmission/reception log, as the log data.

When it is not necessary to make distinction between the access log and the email transmission/reception log, a term referred to as the log data, which indicates both of the access log and the email transmission/reception log is used.

The relay apparatus 112 is also referred to as a proxy or a gateway.

The relay apparatus 112 includes a function of filtering an access request to a specified URL or IP (Internet Protocol) address or a mail to a specified email address.

The enterprise's internal network 103 includes a router apparatus 121, switch devices 122 to 124, and a communication cable that connects the router apparatus and the switch devices 122 to 124.

Terminal devices 141 to 146 are connected to the switch device 122 to 124. Each of the terminal devices 141 to 146 is used by a user in the enterprise for business.

Each of the terminal devices 141 to 146 accesses the Internet 101 or another terminal device through a corresponding one of the switch device 122 to 124 and the router apparatus 121. Each of the router apparatus 121 and the switch devices 122 to 124 periodically generates traffic information.

The traffic information will be described later.

An abnormality detection apparatus 131 monitors a behavior of traffic that flows through the enterprise's internal network 103, and detects occurrence of abnormal traffic.

The behavior of traffic is defined as a time-series characteristic variation of a value obtained by aggregating the traffic information collected from each of the apparatus and the devices (router apparatus and switch devices) that constitute the enterprise's internal network 103.

As a method of aggregating the traffic information, aggregation of the number of generation of data per unit time or a data transfer amount per unit time without setting any condition may be considered. Alternatively one can conceive of aggregating the number of data per unit time or a data transfer amount per unit time, corresponding to any one of or any combination of a source IP address, a destination IP address, a transmission source port number, and a destination port number.

The traffic behavior indicates the time-series characteristic variation of the value obtained as a result of the aggregation as described above.

When a characteristic variation amount obtained by aggregating the traffic information exceeds a predetermined level, the abnormality detection apparatus 131 determines that a traffic abnormality has occurred.

For example, when the data transfer amount per unit time has abruptly increased in a given unit time, the abnormality detection unit 131 determines that the traffic abnormality has occurred.

The traffic information herein means packet dump data or flow statistic information for each packet transmitted from each terminal device.

The packet dump data is recorded data of the packet that has flown at a certain observation point on the network, without alteration.

Data communication by the terminal device is defined in terms of the concept of a flow, and the flow statistic information is recorded statistic information such as the number of transmitted packets, the number of received packets, a data transmitted byte amount, and a data received byte amount for each flow of communication performed by the terminal device.

Common examples of the flow statistic information are NetFlow, sFlow, or the like.

The packet dump data and the flow statistic information both include observation time information and information on the source IP address, the destination IP address, the source port number, and the destination port number.

The observation time information includes a packet transmission time.

The source IP address is the communication address of the terminal device of a packet transmission source, while the destination IP address is the communication address of a packet transmission destination.

When each of the router apparatus 121 and the switch devices 122 to 124 included in the enterprise's internal network 101 does not include a function of generating the traffic information, a sensor dedicated to generating the traffic information may be disposed on the enterprise's internal network 101 to collect the traffic information.

A relay apparatus log analysis apparatus 132 analyzes the access log (or email transmission/reception log) recorded in the relay apparatus 112.

Details of the relay apparatus log analysis apparatus 132 will be described later.

The relay apparatus log analysis apparatus 132 is an example of an internal network management system.

A shared DB (Database) apparatus 133 records the traffic information generated by the router apparatus 121 and the switch devices 122 to 124.

Each of the abnormality detection apparatus 131 and the relay apparatus log analysis apparatus 132 can access the shared DB apparatus 133, and can obtain the traffic information from the shared DB apparatus 133.

FIG. 1 describes only the configuration necessary for concisely describing the content of this embodiment, and does not limit a network configuration when actually configuring a network to which this embodiment is applied.

This embodiment focuses on a malware countermeasure process starting from detection of a traffic abnormality by the abnormality detection apparatus 131. Thus, no particular limitation is imposed on a method of implementing the abnormality detection apparatus 131 in this embodiment.

It is, however, assumed that the abnormality detection apparatus 131 includes at least a function of detecting a traffic abnormality and a function of identifying the IP address (abnormality occurrence address) of the terminal device (abnormality occurrence terminal device) being the origin of abnormal traffic.

The terminal device that has caused the abnormal traffic is the one that may have been infected with malware.

Hereinafter, the terminal device that has caused the abnormal traffic, namely, the terminal device that may have been infected with the malware is also referred to as a malware infected terminal.

In addition to the above-mentioned functions, the abnormality detection apparatus 131 may further include a function of identifying the MAC (Media Access Control) of the terminal device from the identified IP address, and at least one of functions to isolate the malware infected terminal from the enterprise's internal network 103 based on the IP address and the MAC address (the functions such as filtering of specific communication or linkdown of a connection port using the router apparatus or the switch device that forms the enterprise's internal network, and filtering using a personal firewall on the terminal).

Next, details of the relay apparatus log analysis apparatus 132 will be described.

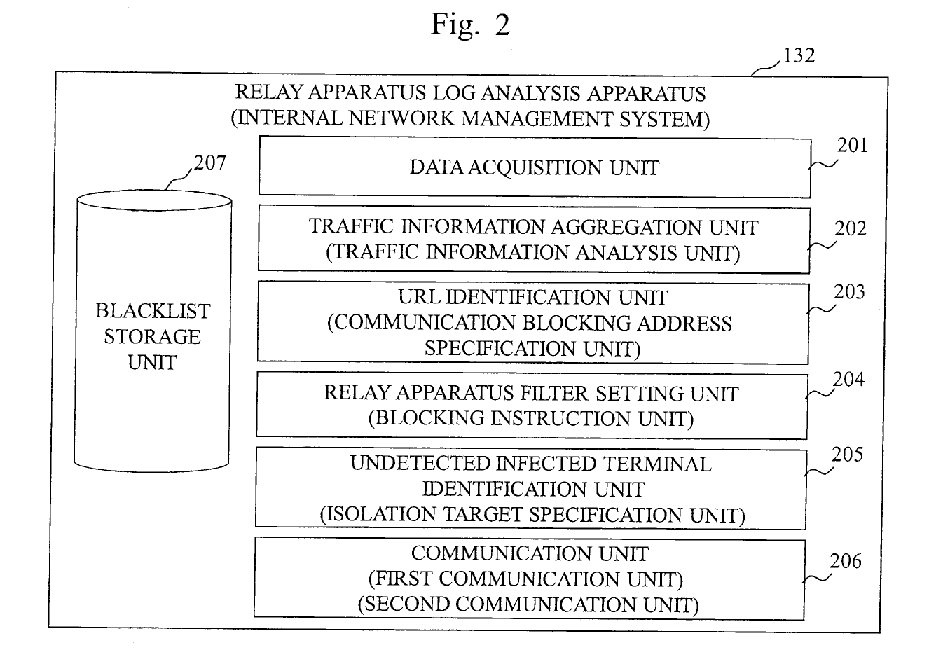

FIG. 2 shows a configuration example of the relay apparatus log analysis apparatus 132.

A data acquisition unit 201 receives from the abnormality detection apparatus 131 an abnormality detection message that notifies detection of a traffic abnormality through a communication unit 206, which will be described later, when the abnormality detection apparatus 131 detects the traffic abnormality.

The data acquisition unit 201 obtains the traffic information by accessing the shared DB apparatus 133 through the communication unit 206.

The abnormality detection message indicates at least an identifier for the traffic information from which the abnormality detection apparatus 131 has detected the traffic abnormality, the IP address of a malware infected terminal (abnormality occurrence address), the communication protocol of a flow through which the traffic abnormality has been caused, and the destination port number of the flow through which the traffic abnormality has been caused.

The data acquisition unit 201 obtains the traffic information to be analyzed, using the identifier included in the abnormality detection message.

As the communication protocol of the flow through which the traffic abnormality has been caused, HTTP (HyperText Transfer Protocol), HTTPS (Hypertext Transfer Protocol Security), SSL (Secure Socket Layer), SMTP (Simple Mail Transfer Protocol), or the like, for example, is notified.

As the destination port number, a port number allocated to the HTTP, HTTPS, SSL, or SMTP is notified.

Either one of the communication protocol and the destination port number may be notified. Alternatively, both of the communication protocol and the destination port number may be notified.

The abnormality detection message is an example of an abnormality occurrence address notification.

The data acquisition unit 201 periodically accesses the relay apparatus 112 through the communication unit 206, which will be described later, and obtains the access log (or the email transmission/reception log) recorded in the relay apparatus 112.

In the access log, the source IP address of communication, a communication start time, a communication duration time, a communication method, the destination URL or the destination IP address, a communication result code, a transmitted/received data amount, and the like are recorded for each outbound packet.

In the email transmission/reception log, a transmission data and time, the name (or IP address) of a source host, a destination email address, a source email address are recorded, for each outbound packet.

The source IP address and the source email address of communication respectively correspond to a communication address of a source terminal device of an outbound packet.

The destination URL and the destination IP address and the destination email address respectively correspond to a communication address of a transmission destination of an outbound packet.

The communication start time and the transmission date and time correspond to a process time during which a process on the outbound packet has been performed by the relay apparatus 112.

The communication start time is a time at which the relay apparatus 112 has received the outbound packet or a time at which the relay apparatus 112 has transferred the outbound packet to the Internet 101.

A traffic information aggregation unit 202 aggregates the traffic information obtained by the data acquisition unit 201, and identifies an occurrence time of the flow that has caused the abnormal traffic, that is, the start time of the traffic abnormality.

Aggregation of the traffic information is performed using the IP address of the malware infected terminal identified by the abnormality detection apparatus 131 (IP address notified in the abnormality detection message), the communication protocol relayed by the relay apparatus (communication protocol notified in the abnormality detection message), and the IP address of the relay apparatus (IP address of the relay apparatus stored by the relay apparatus log analysis apparatus 132) as criteria.

Specifically, the traffic information aggregation unit 202 determines whether or not the traffic abnormality has occurred due to communication relayed by the relay apparatus 112, based on the communication protocol or the destination port number notified in the abnormality detection message.

Then, when the traffic abnormality has occurred due to the communication relayed by the relay apparatus 112, the traffic information aggregation unit 202 extracts records including the IP address of the malware infected terminal as the source IP address and the IP address of the relay apparatus 112 as the destination IP address from the traffic information, and aggregates the extracted records.

The start time of the flow that has caused the abnormal traffic is determined from a result of the aggregation.

The traffic information aggregation unit 202 is an example of a traffic information analysis unit.

A URL identification unit 203 analyzes the access log (or the email transmission/reception log) that is the log data obtained by the data acquisition unit 201 to identify the communication address considered to be the source of the malware.

The URL identification unit 203 analyzes the access log (or the email transmission/reception log), based on the time identified by the traffic information aggregation unit 202 and the source IP address (IP address of the malware infected terminal), and extracts a corresponding log record, and identifies the destination URL included in the access log (or the destination email address included in the email transmission/reception log) recorded in the relay apparatus 112.

More specifically, the URL identification unit 203 extracts from the log data the record of the outbound packet (POST method in the HTTP, HTTP communication, transmitted email) in which the process time by the relay apparatus 112 is after the time identified by the traffic information aggregation unit 202 and the source IP address is the IP address
of the malware infected terminal (abnormality occurrence address) identified by the abnormality detection apparatus 131.

Then, the URL identification unit 203 specifies a destination URL (or the destination email address) described as the destination of transmission in the extracted outbound packet record, as a communication blocking address.

Then, the URL identification unit 203 registers the destination URL (or the destination email address) specified as the communication blocking address in the blacklist of a blacklist storage unit 207.

The URL identification unit 203 instructs a relay apparatus filter setting unit 204 to block an outbound packet to the communication blocking address.

In the following description, when there is no need for making distinction between the destination URL and the destination email address, the term of “communication blocking address” will be used to indicate both of the destination URL and the destination email address.

The URL identification 203 is an example of a communication blocking address specification unit.

Based on the instruction from the URL termination unit 203, the relay apparatus filter setting unit 204 performs setting for the relay apparatus 112 so that communication to the destination URL identified by the URL identification unit 203 (or email transmission to the destination email address) is blocked.

To take an example, the relay apparatus filter setting unit 204 transmits to the relay apparatus 112 a message that instructs not to transfer to the Internet 101 the outbound packet having the communication blocking address identified by the URL identification unit 203 as a transmission destination. The relay apparatus filter setting unit 204 is an example of a blocking instruction unit.

A undetected infected terminal identification unit 205 analyzes the access log (or the email transmission/reception log) to determine whether or not there is the terminal device that has tried an access to the URL (or email transmission to the destination email address) that has been set by the relay apparatus filter setting unit 204 to be blocked by the relay apparatus, based on a list of URLs (or destination email addresses) included in the blacklist.

Then, when it is found that there is the terminal device that has tried the access to the URL (or the email transmission to the destination email address) that has been set for blocking, the undetected infected terminal identification unit 205 identifies the IP address of the terminal device.

Since the access to the access destination URL (or the email transmission to the destination email address) of the malware is never performed in a usual operation, the terminal device that has tried the access (or the email transmission to the destination email address) does not cause a traffic abnormality (because the access has been blocked by the relay apparatus 112), but is determined to be the terminal device which is highly likely to be infected with the malware.

As described above, the terminal device that has tried the access to the access destination URL of the malware is the terminal device (isolation target terminal device) that is suspected to be infected with the malware and must be isolated from the enterprise's internal network 103.

The undetected infected terminal identification unit 205 specifies the IP address of the terminal device that must be isolated from the enterprise's internal network 103 as described above. The undetected infected terminal identification unit 205 is an example of an isolation target specification unit.

The undetected infected terminal identification unit 205 notifies to a system manager, for example, the IP address of the terminal device that must be isolated.

When the abnormality detection apparatus 131 includes a function of isolating the terminal device, the undetected infected terminal identification unit 205 may notify the identified IP address through the communication unit 206, and may instruct the abnormality detection apparatus 131 to isolate the terminal device that uses the IP address from the enterprise's internal network 103.

The communication unit 206 receives the abnormality detection message (abnormality occurrence address notification) from the abnormality detection apparatus 131, transmits a request for obtaining the traffic information to the shared DB apparatus 133, and receives the traffic information (traffic information to be analyzed) from the shared DB apparatus 133.

Further, the communication unit 206 periodically transmits a request for obtaining the log data to the relay apparatus 112, and receives the log data from the relay apparatus 112.

The communication unit 206 performs communication for the above-mentioned purposes while managing a physical interface, a transmission control procedure, and a network connection procedure and the like.

The communication unit 206 is an example of a first communication unit and a second communication unit.

The blacklist storage unit 207 stores blacklist information in which the communication blocking addresses identified by the URL identification unit 203 are listed.

Details of each of the apparatuses and the devices that are included in this embodiment were described so far.

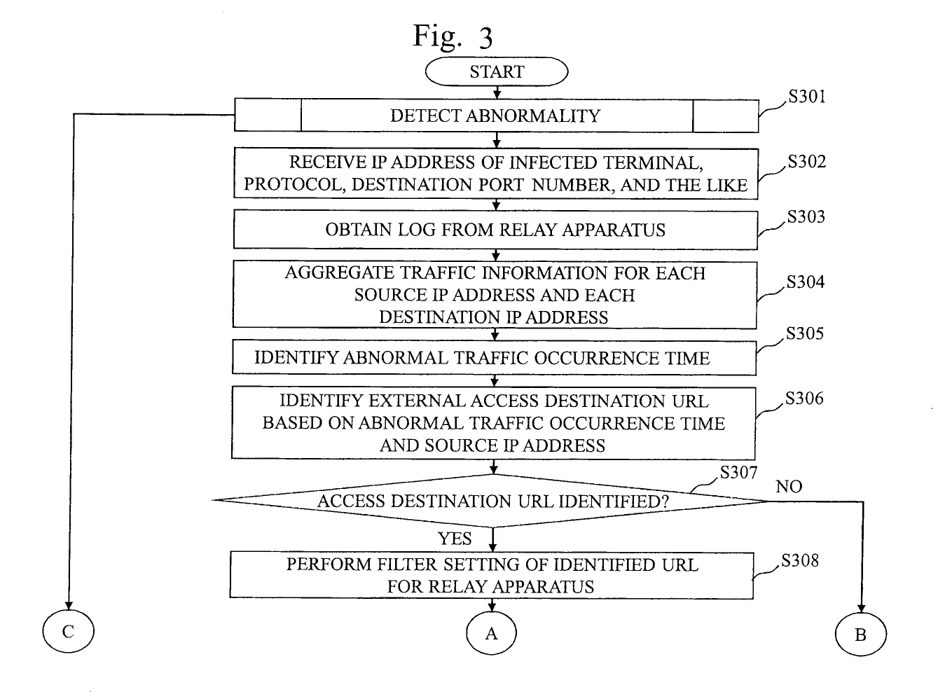

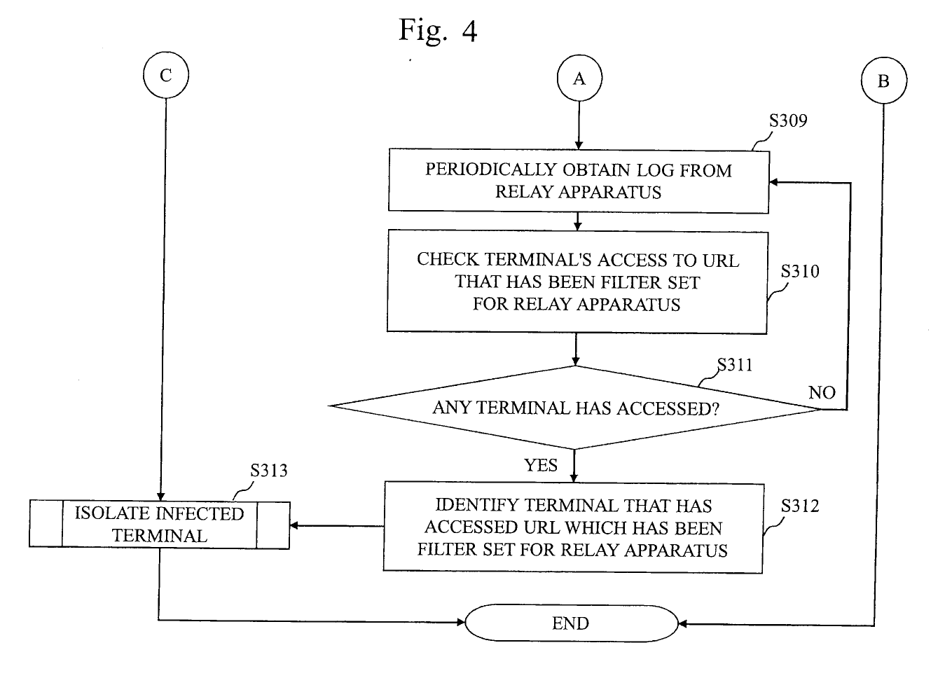

Next, a sequence of flow when the operations of the respective apparatuses and devices function as the overall system will be described. Each of FIGS. 3 and 4 is a flow diagram showing an operation example of the system according to this embodiment.

A detection of an abnormal behavior of traffic by the abnormality detection apparatus 131 starts the malware countermeasure process implemented in this embodiment.

When the abnormality detection apparatus 131 detects the abnormal behavior of traffic (in step S301), the abnormality detection apparatus 131 transmits the abnormality detection message to the relay apparatus log analysis apparatus 132. The abnormality detection message notifies the IP address of the terminal device (malware infected terminal) that generates the abnormal traffic, an identifier for traffic information from which the traffic abnormality has been detected, the communication protocol of a flow that has caused the traffic abnormality, and the destination port number of the flow that has caused the traffic abnormality.

When the abnormality detection apparatus 131 includes the function of isolating the malware infected terminal from the enterprise's internal network 103, the abnormality detection apparatus 131 identifies the MAC address corresponding to the IP address of the malware infected terminal, and performs the process of isolating the malware infected terminal from the enterprise's internal network 103 (in step S313).

When the abnormality detection apparatus 131 does not include the function of isolating the malware infected terminal from the enterprise's internal network 103, the abnormality detection apparatus 131 notifies the system manager of occurrence of the traffic abnormality, the IP address and the MAC address of the malware infected terminal, for example.

The communication unit 206 of the relay apparatus log analysis apparatus 132 receives the abnormality detection message from the abnormality detection apparatus (in step S302) (first communication step).

As described above, the abnormality detection message includes the IP address of the malware infected terminal, the protocol/destination port number, and the traffic information identifier.

Next, in the relay apparatus log analysis apparatus 132, the data acquisition unit 201 periodically generates the request for obtaining log data, the communication unit 206 transmits the request for obtaining the log data to the relay apparatus 112, and receives the log data from the relay apparatus 112 (in step S303) (second communication step).

Since reception of log data from the relay apparatus 112 is periodically performed, the log data may be received in a step after step S304.

Referring to FIG. 3, the communication unit 206 receives the log data in steps S302 and S304, for explanatory purpose.

Herein, the relay apparatus 112 transmits the log data, based on the request for obtaining the log data from the data acquisition unit 201. The relay apparatus 112 may autonomously transmits the log data in a certain cycle without receiving the request for obtaining the log data.

Next, the traffic information aggregation unit 202 determines whether or not communication that has caused the abnormal traffic is relayed by the relay apparatus 112, based on the protocol/destination port number of the abnormal traffic.

When the communication protocol notified by the abnormality detection message is the HTTP, the HTTPS, the SSL, or the SMTP, or when the destination port number notified by the abnormality detection message is the port number allocated to the HTTP, the HTTPS, the SSL, or the SMTP, the communication that has caused the abnormal traffic is relayed by the relay apparatus 112.

When the communication that has caused the abnormal traffic is relayed by the relay apparatus 112, the data acquisition unit 201 generates the request for obtaining the traffic information including the identifier notified by the abnormality detection message, and the communication unit 206 transmits the request for obtaining the traffic information to the shared DB apparatus 133 and receives the traffic information to be analyzed from the shared DB apparatus 133.

Then, the traffic information aggregation unit 202 aggregates the traffic information to be analyzed received by the communication unit 206 (in step S304) and identifies a time at which the abnormal traffic has occurred (in step S305).

Specifically, the traffic information aggregation unit 202 extracts from the traffic information to be analyzed a record including the IP address of the malware infected terminal as the source IP address, and the IP address of the relay apparatus 112 as the destination IP address.

Then, the traffic information aggregation unit 202 identifies a most recent one of packet transmission times shown in the extracted record (or derived from the extracted record) as the occurrence time of the abnormal traffic.

Next, the URL identification unit 203 analyzes the log data obtained in step S303, based on the occurrence time of the abnormal traffic identified in step S305 and the IP address of the malware infected terminal notified by the abnormality detection message. Then, the URL identification unit 203 identifies the access destination URL to the Internet 101 from the malware infected terminal or the destination email address (in step S306).

More specifically, the URL identification unit 203 extracts from the log data a record of an outbound packet where the process time by the relay apparatus 112 is after the occurrence time of the abnormal traffic and the transmission source address is the IP address of the malware infected terminal, and extracts the transmission destination address of the outbound packet indicated in the extracted record (derived from the extracted record), as the communication blocking address.

When the access destination URL is identified by the URL identification unit 203 (YES in step S307), the relay apparatus filter setting unit 204 performs filtering setting for the relay apparatus 112 so that the outbound packet having the access destination URL as the destination address is not transferred to the Internet 101 (in step S308).

When the destination email address is identified (YES in step S307), the relay apparatus filter setting unit 204 performs filtering setting for the relay apparatus 112 so that the mail (outbound packet) having the destination email address as the destination address is not transferred to the Internet 101 (in step S308).

By performing filtering setting for the relay apparatus 112 as described above, the outbound packet for the communication blocking address transmitted from one of the terminal devices 141 to 146 of the enterprise's internal network 103 is blocked by the relay apparatus 112, and is not sent out to the Internet 101.

However, the malware infected terminal device transmits an outbound packet to the communication blocking address, irrespective of whether the blocking by the relay apparatus 112 is performed or not. Accordingly, the log data in the relay apparatus 112 is to record that a terminal device has transmitted the outbound packet destined for the communication blocking address.

The communication unit 206 of the relay apparatus log analysis apparatus 132 periodically receives from the relay apparatus 112 log data generated by the relay apparatus 112 after filtering setting has been performed for the relay apparatus 112 (in step S309).

Each time when the communication unit 206 receives the log data, the undetected infected terminal identification unit 205 checks whether or not there is a record of the outbound packet whose transmission destination address is the URL (communication blocking address) for which filtering setting has been performed (the outbound packet has been blocked by the relay apparatus 112) (in step S310).

No explanation was made relating to the step S303 in order to avoid complexity of the description, however, receiving the log data from the relay apparatus 112 in step S303, starts the processes after step S310 as a different routine, concurrently with the processes after step S304.

When the undetected infected terminal identification unit 205 finds the record of the outbound packet whose transmission destination address is the communication blocking address (YES in step S311) as a result of the process in step S310, the undetected infected terminal identification unit 205 determines that the terminal device being the source of the outbound packet is highly likely to be infected with malware. The undetected infected terminal identification unit 205 identifies the IP address of the transmission source of the outbound packet (in step S312), and instructs to isolate the terminal device of the transmission source of the outbound packet from the enterprise's internal network 103.

Specifically, the undetected infected terminal identification unit 205 notifies the abnormality detection apparatus 131 or the system manager of the IP address of the terminal device to be isolated, and instructs the abnormality detection apparatus 131 or the system manager to isolate the terminal device from the enterprise's internal network 103.

As a result, the abnormality detection apparatus 131 or the system manager isolates the terminal device to be isolated from the enterprise's internal network 103 (in step S313).

As described above, according to this embodiment, the malware infected terminal is isolated based on a result of detection by the abnormality detection apparatus. In addition, the relay apparatus performs dynamic filtering for the URL on the Internet to which the malware tries to access. The isolation and the dynamic filtering may prevent expansion of damage by the malware.

In other words, communication to a communicating destination from unknown malware not listed in the blacklist may also be effectively blocked. The blocking may prevent expansion of damage by the malware.

The log data after filtering setting has been set for the relay apparatus is analyzed to identify another terminal device that may have been infected with the malware. Then, the identified terminal device is isolated. Accordingly, spread of the malware within the enterprise's network may be prevented.

As described above, in this embodiment, the description was directed to the relay apparatus log analysis apparatus that performs the following operations of:

1) aggregating traffic information to identify an occurrence time of abnormal traffic;

2) analyzing the log of the relay apparatus based on the identified time and IP address information on the malware infected terminal, thereby identifying the URL that may be accessed by the malware; and

3) dynamically performing filter setting of the identified URL for the relay apparatus.

In this embodiment, the description was directed to the relay apparatus log analysis apparatus's identifying the IP address of a secondary malware infected terminal that has tried access to the URL of which filter setting has been dynamically set for the relay apparatus.

In this embodiment, the malware countermeasure apparatus, the malware countermeasure system and the malware countermeasure service, including the relay apparatus log analysis apparatus were described.

In the above description, an example where the relay apparatus log analysis apparatus 132 periodically receives log data from the relay apparatus 112 was shown. The log data does not need to be periodically received.

The relay apparatus log analysis apparatus 132 may receive the log data from the relay apparatus 112, triggered by a specific event such as reception of an instruction from the system manager.

Finally, a hardware configuration example of the relay apparatus log analysis apparatus 132 shown in this embodiment will be described.

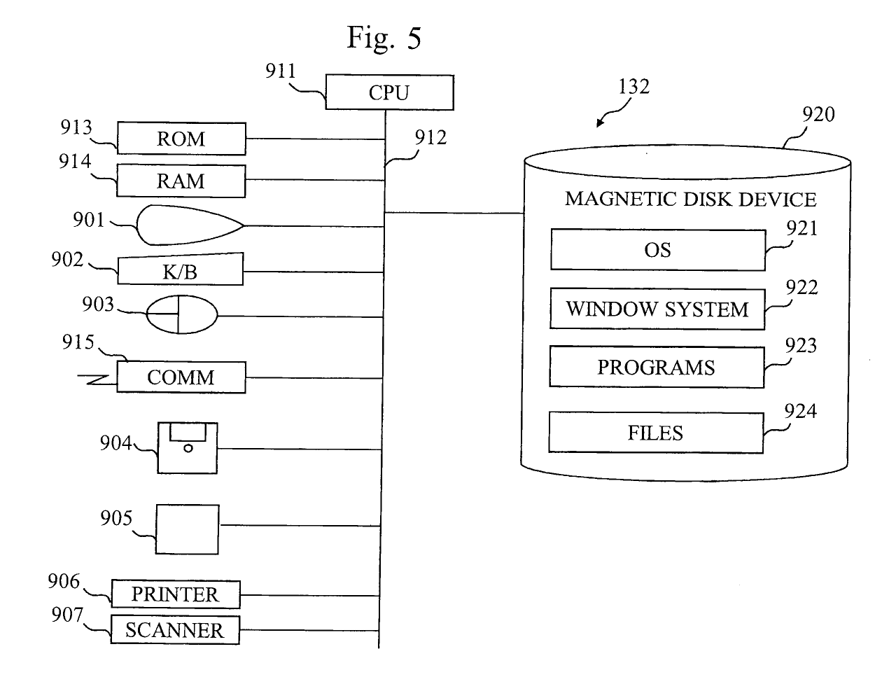

FIG. 5 is a diagram showing an example of hardware resources of the relay apparatus log analysis apparatus 132 shown in this embodiment.

The configuration in FIG. 5 shows just one example of the hardware configuration of the relay apparatus log analysis apparatus 132. The hardware configuration of the relay apparatus log analysis apparatus 132 is not limited to the configuration described in FIG. 5, and a different configuration may be used for the relay apparatus log analysis apparatus 132.

Referring to FIG. 5, the relay apparatus log analysis apparatus 132 includes a CPU 911 (Central Processing Unit, which is also referred to as a central processing device, a processing unit, an arithmetic operation unit, a microprocessor, a microcomputer, or a processor).

The CPU 911 is connected to a ROM (Read Only Memory) 913, a RAM (Random Access Memory) 914, a communication board 915, a display device 901, a keyboard 902, a mouse 903, and a magnetic disk device 920 through a bus 912, for example, and controls these hardware devices.

Further, the CPU 911 may be connected to an FDD (Flexible Disk Drive) 904, a compact disk drive (CDD) 905, a printer device 906, and a scanner device 907. A storage device such as an SSD (Solid State Drive), an optical disk device, a memory card (registered trademark), or a read/write device may be used in place of the magnetic disk device 920.

The RAM 914 is an example of a volatile memory. A storage medium such as the ROM 913, the FDD 904, the CDD 905, or the magnetic disk device 920 is an example of a nonvolatile memory. Each of these media is an example of a memory device.

The “blacklist storage unit” described in this embodiment is implemented by the RAM 914, the magnetic disk device 920, and the like.

Each of the communication board 915, the keyboard 902, the mouse 903, the scanner device 907, and the FDD 904 is an example of an input device.

Each of the communication board 915, the display device 901, and the printer device 906 is an example of an output device.

The communication board 915 is connected to the enterprise's internal network as shown in FIG. 1.

An operating system (OS) 921, a window system 922, programs 923, and files 924 are stored in the magnetic disk device 920.

Each program of the programs 923 is executed by the CPU 911, while the CPU 911 uses the operating system 921 and the window system 922.

At least one portion of programs of the operating system 921 and an application program that is executed by the CPU 911 is temporarily stored in the RAM 914. Various data necessary for processes by the CPU 911 are stored in the RAM 914.

A BIOS (Basic Input Output System) program is stored in the ROM 913, and a boot program is stored in the magnetic disk device 920.

When the relay apparatus log analysis apparatus 132 is activated, the BIOS program in the ROM 913 and the boot program in the magnetic disk device 920 are executed. The operating system 921 is started by the BIOS program and the boot program.

The program for executing the function described as the “- - - unit” (the same as below except the “blacklist storage unit”) in the description of this embodiment is stored in the programs 923. The program is read and executed by the CPU 911.

In the files 924, information, data, signal values, variable values, and parameters showing results of the processes described as “determination of - - -”, “computation of - - -”, “comparison of - - -”, “check of - - -”, “specification of - - -”, “identification of - - -”, “instruction of - - -”, “extraction of - - -”, “detection of - - -”, “updating of - - -”, “setting of - - -”, “registration of - - -”, “selection of - - -” are stored as respective items of “- - - files”, “- - - databases”.

The “- - - files” and “- - - databases” are stored in a storage medium such as a disk and a memory.

The information, the data, the signal values, the variable values, and the parameters stored in the storage medium such as the disk and the memory are loaded into a main memory or a cache memory by the CPU 911 through a read/write circuit.

Then, the information, the data, the signal values, the variable values, and the parameters that have been read are used for operations of the CPU such as extraction, retrieval, reference, comparison, arithmetic operation, computation, processing, editing, output, printing, and display.

During the operations of the CPU such as extraction, retrieval, reference, comparison, arithmetic operation, computation, processing, editing, output, printing, and display, the information, the data, the signal values, the variable values, and the parameters are temporarily stored in the main memory, a register, the cache memory, a buffer memory, or the like.

An arrow portion in the flowcharts described in this embodiment mainly indicates a data or signal input/output.

The data and the signal values are recorded in recording media such as the memory of the RAM 914, the flexible disk of the FDD 904, the compact disk of the CDD 905, the magnetic disk of the magnetic disk device 920, and other optical disk, minidisk, and DVD.

The data and signals are on-line transmitted through the bus 912, signal lines, cables, or the other transmission media.

The “- - - unit” described in this embodiment may be a “- - - circuit”, an “- - - apparatus”, or a “- - - device”. Alternatively, the “- - - unit” may be a “- - - step”, a″- - - procedure”, or a “- - - process”.

That is, the internal network management method according to the present invention may be implemented by the steps, the procedures, and the processes shown in the flowcharts described in this embodiment.

Alternatively, the “- - - unit” described herein may be implemented by firmware stored in the ROM 913.

Alternatively, the “- - - unit” described herein may be implemented only by software, only by hardware such as elements, devices, a substrate, or wires, or by a combination of the software and the hardware, or further, by a combination of the software and the firmware.

The firmware and the software are stored in the recording media such as the magnetic disk, the flexible disk, the optical disk, the compact disk, the minidisk, and the DVD, as the programs.

Each program is read from the CPU 911 and is executed by the CPU 911.

That is, the program has a computer function as the “- - - unit” in this embodiment. Alternatively, the program has the procedure or method of the “- - - unit ” in this embodiment executed by the computer.

As described above, the relay apparatus log analysis apparatus shown in this embodiment is the computer including the CPU as the processing device, the memories, the magnetic disks, and the like as memory devices, the keyboard, the mouse, and the communication board as input devices, and the display device and the communication board as output devices.

Then, as described above, the functions shown as the “- - - units” are implemented by these processing device, memory devices, input devices, and output devices.

1. An internal network management system that manages an internal network including a plurality of terminal devices and an abnormality detection apparatus which detects a traffic abnormality using traffic information, and communicates with a relay apparatus that connects the internal network and an external network, the internal network management system comprising:
a first communication unit that receives an abnormality occurrence address notification notifying an abnormality occurrence address being a communication address of an abnormality occurrence terminal device identified by the abnormality detection apparatus as an origin of a traffic abnormality occurred in the internal network, and receives, as traffic information to be analyzed, the traffic information from which the abnormality detection apparatus has detected the traffic abnormality;
a traffic information analysis unit that analyzes the traffic information to be analyzed, based on the abnormality occurrence address indicated by the abnormality occurrence address notification and the communication address of a terminal device being a transmission source of a packet indicated and a transmission time of the packet indicated in the traffic information to be analyzed, and identifies a start time of the traffic abnormality detected by the abnormality detection apparatus.;
a second communication unit that receives from the relay apparatus log data indicating a communication address of a transmission source, a communication address of a transmission destination, and a process time at which a process on each outbound packet has been performed at the relay apparatus, for each outbound packet transmitted from the internal network to the external network;
a communication blocking address specification unit that extracts, from the log data received by the second communication unit, the outbound packet in which the process time at the relay apparatus is after the start time of the traffic abnormality identified by the traffic information analysis unit and the communication address of the transmission source is the abnormality occurrence address, and specifies the communication address of a transmission destination of the extracted outbound packet as a communication blocking address; and
a blocking instruction unit that instructs the relay apparatus not to transfer to the external network the outbound packet having the communication blocking address specified by the communication blocking address specification unit as the transmission destination.

2. The internal network management system according to claim 1, wherein
the second communication unit receives from the relay apparatus the log data generated by the relay apparatus after the instruction from the blocking instruction unit to the relay apparatus has been made; and
the internal network management system further includes:
an isolation target specification unit that extracts, from the log data received by the second communication unit, the outbound packet in which the communication address of the transmission destination is the communication blocking address, and specifies the communication address of the transmission source of the extracted outbound packet as the communication address of an isolation target terminal device to be isolated from the internal network.

3. The internal network management system according to claim 2, wherein
the second communication unit repeatedly receives the log data from the relay apparatus that generates the log data in a predetermined cycle; and
the isolation target specification unit searches the received log data for the outbound packet in which the communication address of the transmission destination is the communication blocking address, each time when the second communication unit receives the log data.

4. The internal network management system according to claim 2, wherein
the internal network management system manages the internal network including the abnormality detection apparatus with a function of isolating a specified terminal device from the internal network; and
the isolation target specification unit notifies the communication address of the isolation target terminal device to the abnormality detection apparatus, and instructs the abnormality detection apparatus to isolate the isolation target terminal device from the internal network.

5. The internal network management system according to claim 1, wherein
the internal network management system manages the internal network including the plurality of terminal devices that transmit packets and the abnormality detection apparatus that obtains, for each transmitted packet, traffic information indicating a communication address of a terminal devices being a transmission source and a packet transmission time, analyzes the obtained traffic information to detect a traffic abnormality, and identifies the communication address of the terminal device being an origin of the traffic abnormality; and
the internal network management system communicates with the relay apparatus that connects the internal network and the external network outside the internal network, receives from the internal network the outbound packet destined for the external network, transfers the received outbound packet to the external network, and generates the log data on the received outbound packet.

6. An internal network management method executed by a computer, the computer managing an internal network including a plurality of terminal devices and an abnormality detection apparatus which detects a traffic abnormality using traffic information, and communicating with a relay apparatus that connects the internal network and an external network, the internal network management method comprising:
receiving by the computer an abnormality occurrence address notification notifying an abnormality occurrence address being a communication address of an abnormality occurrence terminal device identified by the abnormality detection apparatus as an origin of a traffic abnormality occurred in the internal network and receiving by the computer, as traffic information to be analyzed, the traffic information from which the abnormality detection apparatus has detected the traffic abnormality;
analyzing by the computer, the traffic information to be analyzed, based on the abnormality occurrence address indicated by the abnormality occurrence address notification and the communication address of a terminal device being a transmission source of a packet indicated and a transmission time of the packet indicated in the traffic information to be analyzed, and identifying by the computer a start time of the traffic abnormality detected by the abnormality detection apparatus;
receiving by the computer from the relay apparatus log data indicating a communication address of a transmission source, a communication address of a transmission destination, and a process time at which a process on each outbound packet has been performed at the relay apparatus, for each outbound packet transmitted from the internal network to the external network;
extracting by the computer, from the log data received, the outbound packet in which the process time at the relay apparatus is after the start time of the traffic abnormality and the communication address of the transmission source is the abnormality occurrence address, and specifying by the computer the communication address of a transmission destination of the extracted outbound packet as a communication blocking address; and
instructing by the computer the relay apparatus not to transfer to the external network the outbound packet having the communication blocking address specified.

7. A program for a computer that manages an internal network including a plurality of terminal devices and an abnormality detection apparatus which detects a traffic abnormality using traffic information, and communicating with a relay apparatus that connects the internal network and an external network, the program having the computer execute:
receiving an abnormality occurrence address notification notifying an abnormality occurrence address being a communication address of an abnormality occurrence terminal device identified by the abnormality detection apparatus as an origin of a traffic abnormality occurred in the internal network and receiving as traffic information to be analyzed, the traffic information from which the abnormality detection apparatus has detected the traffic abnormality;
analyzing the traffic information to be analyzed, based on the abnormality occurrence address indicated by the abnormality occurrence address notification and the communication address of a terminal device being a transmission source of a packet indicated and a transmission time of the packet indicated in the traffic information to be analyzed, and identifying a start time of the traffic abnormality detected by the abnormality detection apparatus;
receiving from the relay apparatus log data indicating a communication address of a transmission source, a communication address of a transmission destination, and a process time at which a process on each outbound packet has been performed at the relay apparatus, for each outbound packet transmitted from the internal network to the external network;
extracting from the log data received, the outbound packet in which the process time at the relay apparatus is after the start time of the traffic abnormality and the communication address of the transmission source is the abnormality occurrence address, and specifying the communication address of a transmission destination of the extracted outbound packet as a communication blocking address; and
instructing the relay apparatus not to transfer to the external network the outbound packet having the communication blocking address specified.
